(19) United States
(12) Patent Application Publication
(10) Pub. No.: US 2002/0123276 A1
(43) Pub. Date: Sep. 5, 2002

(54) Network comprising a plurality of sub-networks which can be linked via bridge terminals

(76) Inventor: Joerg Peetz, Aachen (DE)

Correspondence Address: Philips Electronics, North America Corporation, 580 White Plains Road, Tarrytown, NY, 10591, US

(21) Appl. No.: 10/075,867

(22) Filed: Feb. 13, 2002

(30) Foreign Application Priority Data
Feb. 16, 2001 (DE) 10107816.1

(51) Int. Cl. H01R 9/22

(52) U.S. Cl. 439/894

(57) ABSTRACT

The invention relates to a network comprising a plurality of sub-networks which each include terminals and which exchange data with each other via at least one bridge terminal. A controller for controlling a sub-network connects at least one other bridge terminal for data transfer between at least two sub-networks. The bridge terminals are synchronized with only one sub-network during certain periods.

### DESCRIPTION

The invention relates to a network comprising a plurality of sub-networks which each include terminals. Each sub-network includes a controller for controlling a sub-network. A sub-network of this kind is self-organising and is also known as an ad hoc network.

An ad hoc network with several terminals is known from the document “Broadband Radio Access Networks (BRAN), HIPERLAN Type 2; ‘Functional Specifications; Data Link Control (DLC) Layer; Part 4: Extension for Home Environment’, DTS 101 761-4, ETSI, April 2000”. At least one terminal is provided as the controller for controlling the ad hoc network. Under certain conditions, it may be necessary for another terminal to become the controller. When a network like this reaches a certain size, it needs to be split up into sub-networks. Commnunication with the sub-networks takes place via a terminal arranged as a bridge terminal.

It is an object of the invention to create a network which allows increased data throughput between at least two sub-networks in certain heavy-load situations.

The object is achieved by a network of the type described above by the following measures:

The network comprises a plurality of sub-networks which each include terminals and exchange data with each other via at least one bridge terminal in which a controller for controlling a sub-network is arranged for connecting at least one other bridge terminal for data transfer between at least two sub-networks and the bridge terminals are synchronized with only one sub-network during certain periods.

The network according to the invention comprises at least two bridge terminals for connecting for example two sub-networks, in order to increase the data throughput between two sub-networks in certain heavy-load situations. When only one bridge terminal connects two sub-networks, a sub-network can select a terminal for use as a bridge terminal which is then alternately synchronized with the two sub-networks. A bridge terminal can be synchronized with at least two sub-networks during essentially the same period of time.

Claim 3 refers to various messages which are exchanged during a changeover of the sub-networks.

The invention also relates to a bridge terminal in a network comprising a plurality of sub-networks which, together with at least one other bridge terminal, is provided for data exchange between the sub-networks.

These and other aspects of the invention are apparent from and will be elucidated, by way of non-limiting example, with reference to the embodiment(s) described hereinafter.

In the drawings:

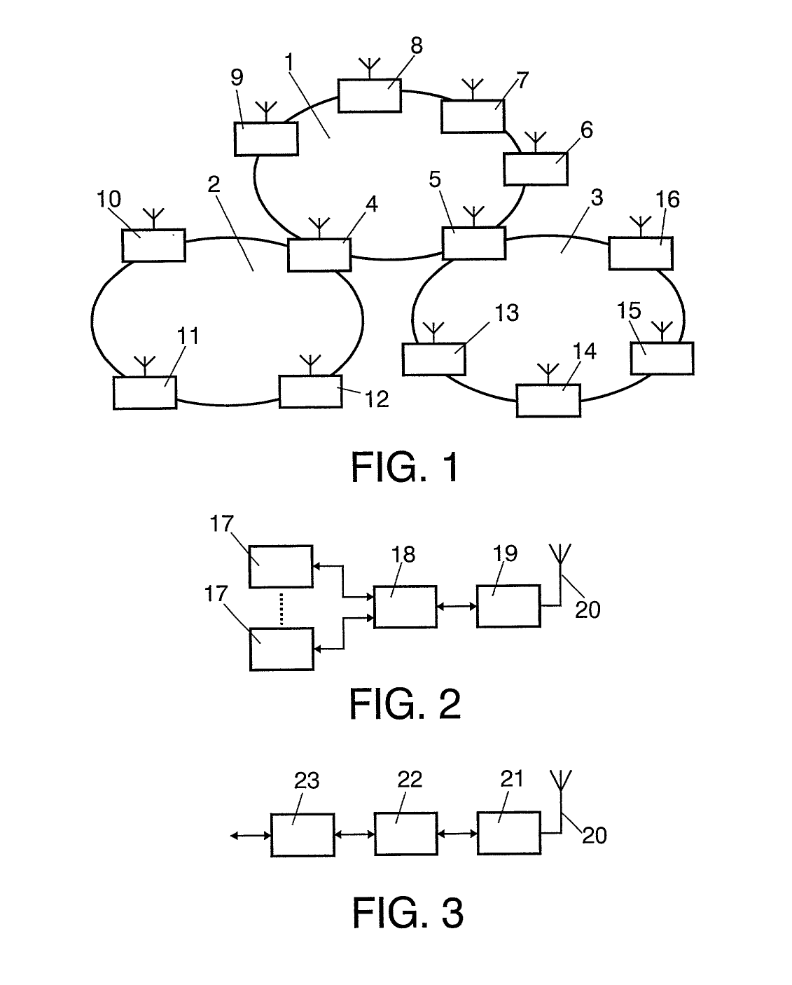

FIG. 1 shows an ad hoc network comprising three sub-networks, each containing terminals to be used for radio transmission.

FIG. 2 shows a terminal of the local area network as shown in FIG. 1.

FIG. 3 shows a radio device of the terminal as shown in FIG. 2.

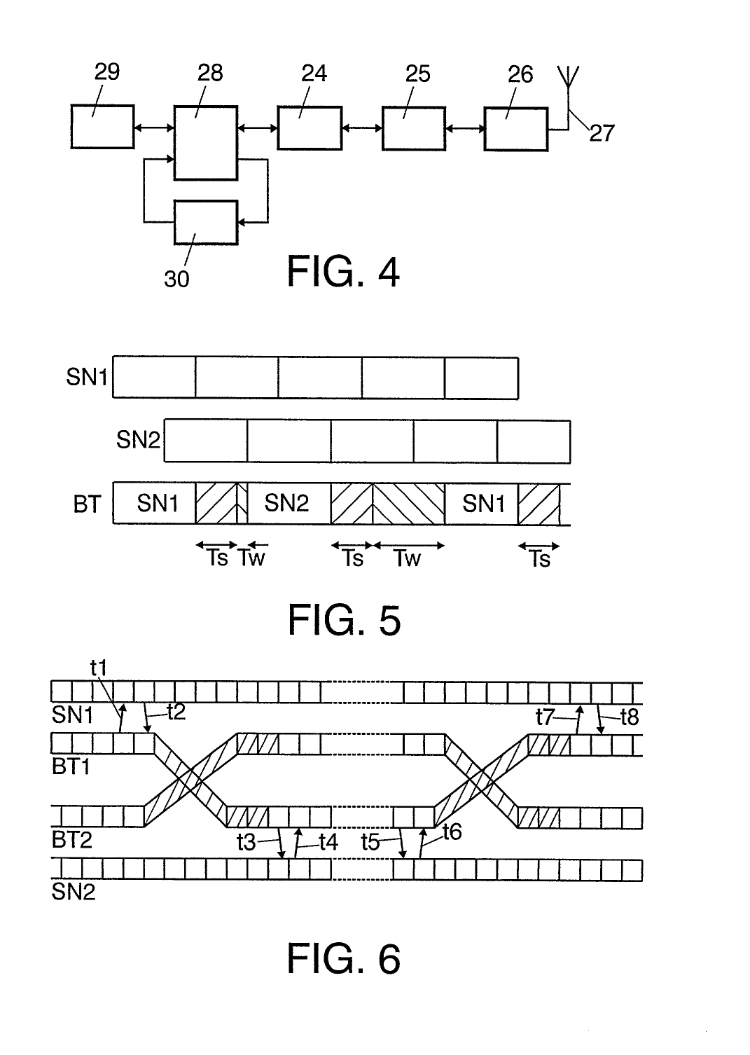

FIG. 4 shows an embodiment of a bridge terminal for connecting two subnetworks.

FIG. 5 shows MAC frames of two sub-networks and the MAC frame structure of one bridge terminal and FIG. 6 shows MAC frames of two sub-networks and the MAC frame structure of two bridge terminals.

The following example of embodiment refers to ad hoc networks which, unlike traditional networks, are self-organising. Each terminal in an ad hoc network such as this can provide access to a fixed network and can be used immediately. An ad hoc network is characterized in that the structure and the number of users is not fixed within predefined limits. For example, a user's communication device can be removed from or connected to the network. Unlike traditional mobile radio networks, an ad hoc network is not dependent on a fixedly installed infrastructure.

The size of the area covered by an ad hoc network is generally much larger than the transmission range of a terminal. To enable communication between two terminals, it may therefore be necessary to connect further terminals which can transfer messages or data between the two communicating terminals. Such ad hoc networks, where a terminal is required to relay signals and data, are known as multi-hop ad hoc networks. One possible way of organising an ad hoc network is to regularly form sub-networks or clusters. A subnetwork of the ad hoc network can be formed, for example, by subscribers sitting around a table using radio-linked terminals. These terminals could take the form of e.g. communication devices for the cordless exchange of documents, images, etc.

There are two types of ad hoc networks—centralised and decentralised. In a decentralised ad hoc network, communication between the terminals is decentralised, i.e. each terminal can communicate directly with every other terminal, provided that the terminals are all in the transmission range of the other terminals. The advantage of a decentralised ad hoc network is its ease of use and robustness to errors. In a centralised ad hoc network, certain functions such as multiple access of a terminal to the radio transmission medium (medium access control=MAC) are controlled by a particular terminal per subnetwork. This terminal is known as the central terminal or central controller (CC). These functions do not always have to be performed by the same terminal, but can be transferred from one terminal to another, which terminal in turn then takes over as the central controller. The advantage of a central ad hoc network is that it provides in a simple manner an agreement about the quality of service (QoS). An example of a centralised ad hoc network is a network which is organised according to the HIPERLAN/2 Home Environment Extension (HEE) (cf. Broadband Radio Access Networks (BRAN), HIPERLAN Type 2; “Functional Specifications; Data Link Control (DLC) Layer; Part 4: Extension for Home Environment”, DTS 101 761-4, ETSI, Apr. 2000.).

FIG. 1 shows an example of embodiment of an ad hoc network comprising three sub-networks (1 to 3), comprising each contain several terminals (4 to 16). Terminals 4 to 9 belong to sub-network 1, terminals 4 and 10 to 12 to sub-network 2, and terminals 5 and 13 to 16 to sub-network 3. In a sub-network, the terminals belonging to a particular sub-network network exchange data via radio links. The ellipses shown in FIG. 1 illustrate the radio range of a sub-network (1 to 3) in which radio transmission between the terminals belonging to the sub-network is essentially problem-free.

Terminals 4 and 5 are known as bridge terminals, since they allow data exchange between two sub-networks 1 and 2 and/or 1 and 3. The bridge terminal 4 is responsible for the data traffic between sub-networks 1 and 2 and the bridge terminal 5 is responsible for the data traffic between sub-networks 1 and 3.

One terminal 4 to 16 of the local area network in FIG. 1 can be a mobile or fixed communication device containing, for example, at least a station 17, a connection control device 18 and a radio device 19 with antenna 20, as shown in FIG. 2. A station 17 may be a portable computer, telephone, etc.

A radio device 19 of the terminals 6 to 16, as shown in FIG. 3, contains, in addition to the antenna 20, a high frequency circuit 21, a modem 22 and a protocol device 23. The protocol device 23 forms packet units from the data stream received by the connection control device 18. A packet unit contains parts of the data stream and additional control information formed by the protocol device 23. The protocol device uses protocols for the LLC layer (LLC=logical link control) and the MAC layer (MAC=medium access control). The MAC layer controls multiple access of a terminal to the radio transmission medium and the LLC layer performs flow and error control.

As mentioned above, a particular terminal in a sub-network 1 to 3 of a centralized ad hoc network is responsible for the control and management functions and is referred to the central controller. The controller also functions as a normal terminal in the associated sub-network. The controller is responsible for, for example, registering terminals which start activity in the sub-network, setting up a connection between at least two terminals in the radio transmission medium, managing resources and controlling access in the radio transmission medium. Thus, for example, following registration and notification of a transmission request, the controller assigns transmission capacity for data (packet units) to a terminal in a sub-network.

In the ad hoc network, data can be exchanged between the terminals according to a TDMA (time division multiple access), FDMA (frequency division multiple access) or CDMA method (code division multiple access). The methods can also be combined. A number of specific channels, known as channel groups, are assigned to each sub-network 1 to 3 of the local area network. A channel is defined by a frequency range, a time range and, for example, in the CDMA method by a spreading code. For example, a specific, respectively different frequency range having a carrier frequency f₁ can be made available to each subnetwork 1 to 3 for data exchange. In such a frequency range, data can be transferred using, for example, the TDMA method. Sub-network 1 can be assigned the carrier frequency f₁, sub-network 2 the carrier frequency f₂ and sub-network 3 the carrier frequency f₃. The bridge terminal (4) works with the carrier frequency f₁, on the one hand, to enable it to exchange data with the other terminals in the sub-network 1, and with the carrier frequency f₂, on the other hand, to enable it to exchange data with the other terminals of the sub-network 2. The second bridge terminal (5) in the local area network, which transfers data between the subnetworks 1 and 3, works with the carrier frequencies f₁ and f₃.

As mentioned above, one of the central controller's functions is that of access controller. This means that the central controller is responsible for forming the frames of the MAC layer (MAC frames). The TDMA method is used for this purpose. A MAC frame such as this has various channels for control information and useful data.

A block diagram of an example of embodiment of a bridge terminal is shown in FIG. 4. The radio switching device of this bridge terminal contains a protocol device 24, a modem 25 and a high-frequency circuit 26 with antenna 27. A radio switching device 28 is combined with the protocol device 24 and is connected to a connection control device 29 and a buffer device 30. The buffer device 30 in this embodiment contains a storage element and performs data buffering and functions as a FIFO component (first in first out), i.e. the data is read from the buffering device 30 in the order in which it was written. The terminal shown in FIG. 4 can also function as a normal terminal. Stations connected to the connection control device 29 (which are not shown in FIG. 4) supply data to the radio switching device 28 via the connection control device 29.

The bridge terminal shown in FIG. 4 is synchronized alternately with a first and second sub-network. Synchronization refers to the whole process from linking a terminal in the sub-network through to data exchange. When the bridge terminal is synchronized with the first sub-network, it can exchange data with all the terminals and with the controller of this first sub-network. If data destined for a terminal or the controller of the first sub-network or a terminal or controller of another sub-network which can be reached via the first subnetwork is transported from the connection control device 29 to the radio switching device 28, then the radio switching device relays this data directly to the protocol device 24. The data is buffered in the protocol device 24 until the time window which the controller has specified for the transfer is reached. If the data output by the connection control device 29 needs to be sent to a terminal or the controller of the second sub-network or to another subnetwork that can be reached via the second sub-network, then the radio transfer must be delayed until the time window when the bridge terminal is synchronized with the second subnetwork. The radio switching device relays data, whose destination is either in the second sub-network or can be reached via the second sub-network, to the buffering device 30 which then buffers the data until the bridge terminal is synchronized with the second sub-network.

When data from a terminal or from the controller of the first sub-network, whose destination is a terminal or the controller of the second sub-network or a terminal or controller of another sub-network that can be reached via the second sub-network, is received by the bridge terminal, then this data is also stored in the buffering device 30 until synchronization is realized with the second sub-network. Data whose destination is a station of the bridge terminal is passed directly via the radio switching device 28 to the connection control device 29 which then relays the data received to the required station. Data whose destination is neither a station of the bridge terminal nor a station or controller of the second sub-network may be sent to another bridge terminal, for example.

After the synchronization changeover of the bridge terminal from the first to the second sub-network, the data located in the buffering device 30 is once again read from the buffering device 30 in the order in which it was written. While the bridge terminal is being synchronized with the second sub-network, all data whose destination is a terminal or the controller of the second sub-network or another sub-network that can be reached via the second sub-network can be transferred immediately from the radio switching device 28 to the protocol device 24 and only the data whose destination is a terminal or the controller of the first sub-network or another sub-network that can be reached via the first sub-network is stored in the buffering device 30.

The MAC frames of two sub-networks SN1 and SN2 are generally not synchronized. A bridge terminal BT is therefore not connected to a sub-network SN1 or SN2 only during a changeover time Ts but not during a waiting period Tw either. This can be seen in FIG. 5 which shows a sequence of MAC frames of sub-networks SN1 and SN2 and the MAC frame structure of the bridge terminal BT. The changeover time Ts is the time needed for the bridge terminal to synchronize itself with a sub-network. The waiting period Tw refers to the time between the end of the synchronization with the sub-network and the beginning of a new MAC frame of this sub-network.

The bridge terminal BT, which may be synchronized with the first subnetwork SN1, for example, sends a signal (absence message) to the controller of the first subnetwork SN1 before the changeover to the second sub-network SN2, which communicates to the controller of the first sub-network SN1 the duration of absence or the duration of the connection with the second sub-network SN2. Only when the controller of the first sub-network SN1 answers with an acknowledge signal does the bridge terminal BT change the carrier frequency and try to synchronize with the second sub-network. The bridge terminal first sends a signal (presence message) to the controller of the second sub-network SN2 indicating that the bridge terminal BT is awaiting synchronization with the second subnetwork SN2. The controller of the second sub-network SN2 answers with an acknowledge signal. The same process takes place when the bridge terminal changes back over to the first sub-network SN1.

The absence, presence and acknowledge messages can all be sent via a broadcast or random-access channel. After an acknowledge signal has been sent in response to an absence message by a controller, the controller then starts a counting process to count the MAC frames. After a certain number of MAC frames specified by the absent bridge terminal, the bridge terminal absent up until then will log on once again with a presence message. Because it knows the duration of the bridge terminal's period of absence, the controller can prepare for different load and traffic conditions in the sub-network.

The period of absence/presence of the bridge terminal in a sub-network may be either the same or different. It depends on the load conditions in each of the two subnetworks.

In order to increase the data throughput between two sub-networks in certain load situations, the invention allows two sub-networks to be connected with each other by at least a second bridge terminal. To do this, a controller of a sub-network can select one terminal to be used as a bridge terminal. If the data throughput is to be increased further, other terminals can be used as bridge terminals.

An example of a case such as this can be seen in FIG. 6, which shows a sequence of MAC frames for the two sub-networks SN1 and SN2 and the two bridge terminals BT1 and BT2. In FIG. 6, the bridge terminal BT1 is synchronized with the subnetwork SN1 and the bridge terminal BT2 with the sub-network SN2 at the beginning of the MAC frames segment. At time t1, bridge terminal BT1 sends an absence message to the controller of sub-network SN1 which then acknowledge receipt of the signal (time t2). The bridge terminal is then not synchronized with either the first or the second sub-network SN1 or SN2 for a certain period of time. At time t3, bridge terminal BT1 sends a presence message to the controller of the second sub-network SN2 which then acknowledges receipt of the signal with an acknowledge signal at time t4. After a certain number of MAC frames, bridge terminal BT1 needs to change back over to the first sub-network SN1. This changeover phase will be introduced by an absence message t5. After the acknowledge signal t6, synchronization with the first sub-network SN1 begins again. This is terminated by a presence message t7 from the first bridge terminal BT1 and an acknowledge signal from the first sub-network SN1 at time t8. The processes for bridge terminal BT2 are the same as those described for bridge terminal BT1.

Both bridge terminals are generally connected alternately to the two subnetworks. In principle, however, it is also possible for both bridge terminals to be present for a certain period in a single sub-network under certain traffic conditions. As already mentioned above, the period of presence or absence of the two bridge terminals can be either the same or different.

It is also possible for more than two bridge terminals to be connected with the two sub-networks. The bridge terminals can also connect more than two sub-networks with each other.

1. A network comprising a plurality of sub-networks which each include terminals and which exchange data with each other via at least one bridge terminal in which a controller for controlling a sub-network is provided for connecting at least one other bridge terminal for data transfer between at least two sub-networks and file the bridge terminals are synchronized with only one sub-network during certain periods.

2. A network as claimed in claim 1, characterized in that a bridge terminal is synchronized with at least two sub-networks over essentially the same period of time.

3. A network as claimed in claim 1, characterised in that a bridge terminal is provided for sending an absence message to a terminal functioning as a controller of the sub-network with which it is synchronized before the changeover from one sub-network to another sub-network and in that a bridge terminal, after the changeover of the sub-networks, sends a presence message to a terminal functioning as a controller of the sub-network with which it is then synchronized.

4. A bridge terminal in a network comprising a plurality of sub-networks, each containing terminals, which, together with at least one other bridge terminal, is used for exchanging data between the sub-networks and is synchronized with only one sub-network during certain periods of time.
